(19) United States
(12) Patent Application Publication
(10) Pub. No.: US 2013/0067675 A1
(43) Pub. Date: Mar. 21, 2013

(54) Windshield Wiper Connector and Windshield Wiper Connection Assembly

(71) Applicant: Ching-Chuan Chien, Taipei City (TW)

(72) Inventor: Ching-Chuan Chien, Taipei City (TW)

(73) Assignee: Unipoint Electric Manufacturing Co., Ltd., Taipei City (TW)

(21) Appl. No.: 13/237,254

(22) Filed: Sep. 20, 2011

(51) Int. Cl. B60S 1/40

(52) U.S. Cl. 15/250.32

(57) ABSTRACT

A windshield wiper connector and windshield wiper connection assembly. The windshield wiper connector comprises a main body, a lodging device and a flexible fastening device. The lodging device is disposed to a rear of the main body to lodge with a barb portion at random angles. One end of the flexile fastening device is connected below a front of the main body while another end is an extending end upwardly extended toward an upper side of the main body. The flexible fastening device leans against a protruding portion. After the lodging device is hooked with the barb portion, the windshield wiper arm is rotated by taking a hooking portion as an axis so that the extending end propped by the protruding portion performs a deformation toward a direction being distant from the protruding portion. When the protruding portion crosses the extending end, the extending end is restored.

### BACKGROUND OF THE INVENTION

1. Field of the Invention

The present invention relates to a windshield wiper connector and windshield wiper connection assembly, and more particularly to a windshield wiper connector and windshield wiper connection assembly using a flexible fastening body to fasten a windshield wiper arm.

2. Description of the Related Art

Automobiles are important transportation vehicles and now in widespread use. More specifically, it does not only take it as the means of transportation, but also has an effect of keeping out wind and rain more by comparing bicycles and motorcycles during rain.

Each automobile is equipped with windshield wipers and wipes rain during a rainy day so as to enhance driving safety. The windshield wipers are connected to a windshield wiper motor through a windshield wiper connection assembly, thereby achieving a goal of wiping water drops on a surface of a glass.

With reference to FIG. 1 and FIG. 2 for a schematic diagram of a conventional windshield wiper arm and a schematic diagram of a windshield wiper connection assembly is depicted. The windshield wiper arm 1 comprises a first barb portion 11, a second barb portion 12 and a protruding portion 13. The first barb portion 11 and the second barb portion 12 can be respectively disposed at two sides of the windshield wiper arm 1. The protruding portion 13 can be disposed to an end of the windshield wiper arm 1. Components of the windshield wiper connection assembly comprise a windshield wiper connector 200 and a windshield wiper arm 1. The conventional windshield wiper connector 200 is designed with a slot 202 at a front while two sides of a rear are disposed with fixing components 201 made of hardness materials. While assembling with the windshield wiper arm 1, the windshield wiper arm 1 is firstly inserted into the slot 202 of the front of the windshield wiper connector 200, and then the windshield wiper arm 1 is downwardly pressed to utilize the fixing components 201 at two sides of the rear of the windshield wiper connector 200 to wedge the windshield wiper arm 1.

According to the foregoing depiction, the windshield wiper connector that is used for connecting the windshield wiper arm in prior art has the following defects:
1. While detaching the conventional windshield wiper connector from the windshield wiper arm, a user must press the fixing components to separate the windshield wiper arm from the windshield wiper connector. The assembled windshield wiper arm would cover the windshield wiper connector to allow the fixing components locating below the windshield wiper arm. Consequently, when the user would like to press the fixing components, the user must use his (or her) hand to stretch into a bottom of the windshield wiper connector to find out a position of the fixing components. It is difficult to touch and may easily harm the hand of the user so as to cause inconvenience.
2. In the foregoing prior art, the fixing components at the rear of the windshield wiper connector are made of hardness materials. While assembling and detaching the barb portions of the windshield wiper arm, magnitude forces must be imposed to wedge or separate the fixing components and the barb portion. Consequently, the fixing components may be damaged by the barb portions to cause abrasion. Further, the fastening force may be gradually reduced. The windshield wiper connector may not be stably installed with the windshield wiper arm due to the abrasion.

### SUMMARY OF THE INVENTION

In view of the shortcomings of the prior art, the inventor(s) of the present invention based on years of experience in the related industry to conduct extensive researches and experiments, and finally developed a windshield wiper connector and a windshield wiper connection assembly as a principle objective to overcome the problems of unstably installing both that are worn due to long term usage.

To achieve the foregoing objective, the windshield wiper connector is provided and comprises a main body, a lodging device and a flexible fastening device. The lodging device is disposed to a rear of the main body and lodged with a barb portion of a windshield wiper arm. One end of the flexible fastening device is connected below a front of the main body while another end of the flexible fastening device is an extending end upwardly extended toward an upper side of the main body. The flexible fastening device leans against a protruding portion of the windshield wiper arm. After the lodging device is hooked with the barb portion, the windshield wiper arm is rotated by taking a hooking portion as an axis so that the extending end of the flexible fastening is propped by the protruding portion to perform a deformation toward a direction being distant from the protruding portion. When the protruding portion crosses the extending end, the extending end is restored from a deformation state to fasten the protruding portion, thereby fixing the windshield wiper arm on the main body.

The flexible fastening device further comprises a flexible portion and a fastening portion. One end of the flexible portion is disposed below a front of the main body while another end is extended toward an upper side of the main body and connected to the fastening portion to form an extending end. The fastening portion comprises a guiding surface. When the extending end propped by the protruding portion performs a deformation, the guiding surface is in contact with the protruding portion, and the protruding portion is guided by the surface to cross the extending end.

The flexible portion and the fastening portion are connected to form a cavity. When the protruding portion of the windshield wiper arm is approached to the flexible fastening device, the protruding portion leans against the guiding surface to allow the flexible portion to firstly perform the deformation toward the direction being distant from the protruding portion. After the protruding portion crosses the guiding surface, it falls into the cavity leaning against each other so that the fastening portion is hooked with the protruding portion.

According to the objective of the invention, a windshield wiper connection assembly is further provided and comprises a windshield wiper connector and a windshield wiper arm. The windshield wiper connector comprises a main body. Two sides of a rear of the main body are disposed with a first lodging portion and a second lodging portion. A front of the main body is disposed with a flexible fastening body. The flexible fastening body comprises a flexible portion and a fastening portion. The fastening portion further comprises a guiding surface. Two sides of the windshield wiper arm are disposed with a first barb portion and a second barb portion. One end of the windshield wiper arm is disposed with a protruding portion. The first lodging portion and the second lodging portion are respectively hooked with the first barb portion and the second barb portion so that the windshield wiper arm is rotated by taking a hooking portion as an axis. The protruding portion is gradually approached to the guiding surface of the fastening portion and mutually leans against each other to drive the flexible portion to perform a deformation toward a direction being distant from the protruding portion. After the protruding portion crosses the guiding surface and the flexible portion is restored from a deformation state, the fastening portion is fastened to the protruding portion, thereby fixing the windshield wiper arm on the main body.

One end of the flexible portion is disposed below a front of the main body while another end is extended toward an upper side of the main body and connected to the fastening portion to become an extending end. When the extending end propped by the protruding portion performs a deformation, the guiding surface of the fastening portion is in contact with the protruding portion and crosses the extending end.

The flexible portion and the fastening portion are connected to form a cavity. When the protruding portion of the windshield wiper arm leans against the guiding surface, the flexible portion performs the deformation toward the direction being distant from the protruding portion. After the protruding portion crosses the guiding surface and falls into the cavity mutually leaning against each other, the fastening portion is fastened to the protruding portion.

The windshield wiper connector and the windshield wiper connection assembly according to the invention have one or more advantages:
(1) When the windshield wiper connector of the invention is assembled with the windshield wiper arm, the lodging device is hooked with the barb portion of the windshield wiper arm. The windshield wiper arm is rotated by taking a hooking portion as an axis so that the protruding portion crosses the extending end of the flexible fastening device. With the lodging devices hooked with the barb portions and the flexible fastening device hooked with the protruding portion, the windshield wiper arm is fixed to the windshield wiper connector. Since the windshield wiper connector mainly uses the flexible fastening device capable of being deformed to fasten the windshield wiper arm, the flexible fastening device is located onto the windshield wiper connector. While detaching the windshield wiper connector from the windshield wiper arm, a user only twists the flexible fastening device to easily detach the windshield wiper connector from the windshield wiper arm, thereby increasing the convenience in use.
(2) The windshield wiper connector of the invention does not only utilize the lodging device (the first lodging portion and the second lodging portion) to lodge the windshield wiper arm, but also installs the flexible fastening device capable of being deformed to fix the windshield wiper arm. The installation mainly uses the deformation of the flexible fastening device to fix the windshield wiper arm on the windshield wiper connector. Therefore, there is no problem of generating the wearing on the fixing components damaged by the barbs of the windshield wiper arm that is caused by imposing magnitude forces to connect or separate from the windshield wiper arm while assembling or detaching the conventional windshield wiper connector.

### BRIEF DESCRIPTION OF THE DRAWINGS

FIG. 1 is a schematic diagram of a conventional windshield wiper arm;

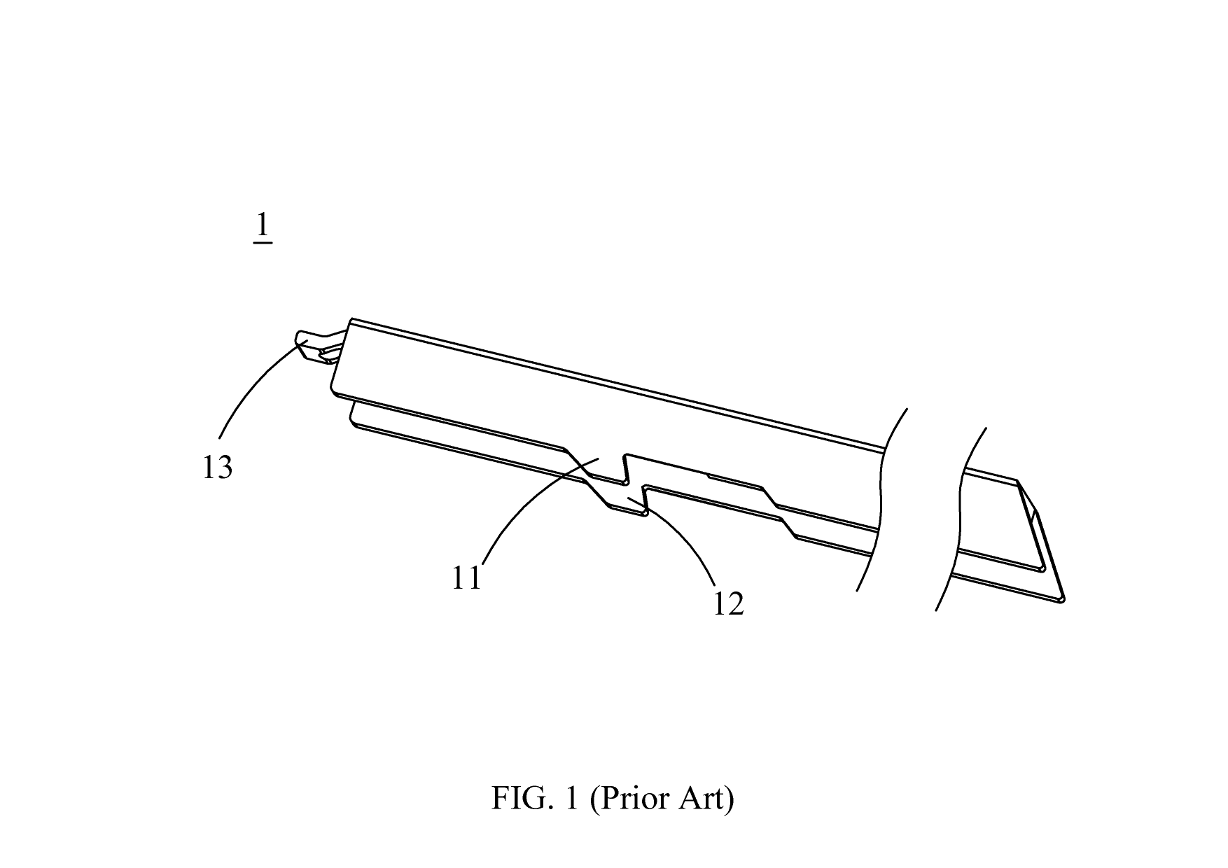

FIG. 2 is a schematic diagram of a conventional windshield wiper connection assembly;

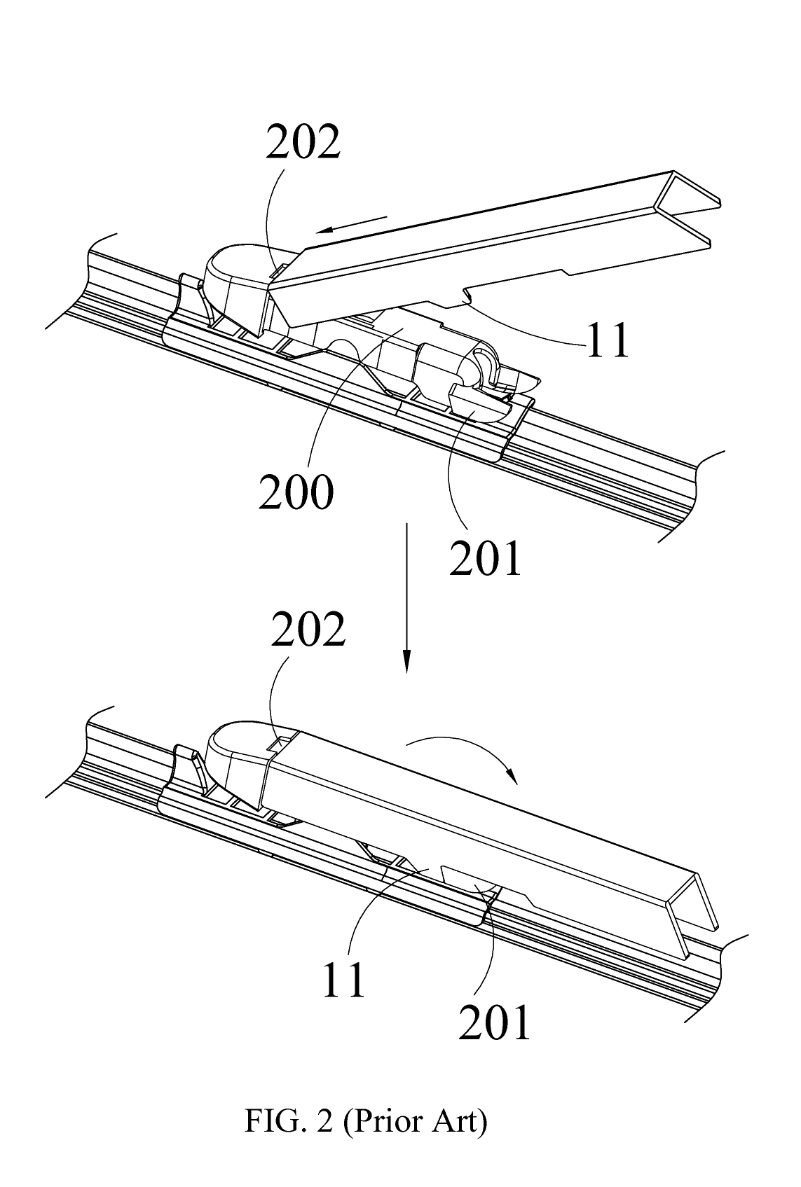

FIG. 3 is a first schematic diagram of a windshield wiper connector according to an embodiment of the invention;

FIG. 4 is a second schematic diagram of a windshield wiper connector according to an embodiment of the invention;

FIG. 5 is a first schematic diagram of assembling a windshield wiper connector with a windshield wiper arm according to an embodiment of the invention;

FIG. 6 is a second schematic diagram of assembling a windshield wiper connector with a windshield wiper arm according to an embodiment of the invention;

FIG. 7 is a third schematic diagram of assembling a windshield wiper connector with a windshield wiper arm according to an embodiment of the invention;

FIG. 8 is a fourth schematic diagram of assembling a windshield wiper connector with a windshield wiper arm according to an embodiment of the invention;

FIG. 9 is a first schematic diagram of detaching a windshield wiper connector from a windshield wiper arm according to an embodiment of the invention;

FIG. 10 is a second schematic diagram of detaching a windshield wiper connector from a windshield wiper arm according to an embodiment of the invention; and

FIG. 11 is a third schematic diagram of detaching a windshield wiper connector from a windshield wiper arm according to an embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

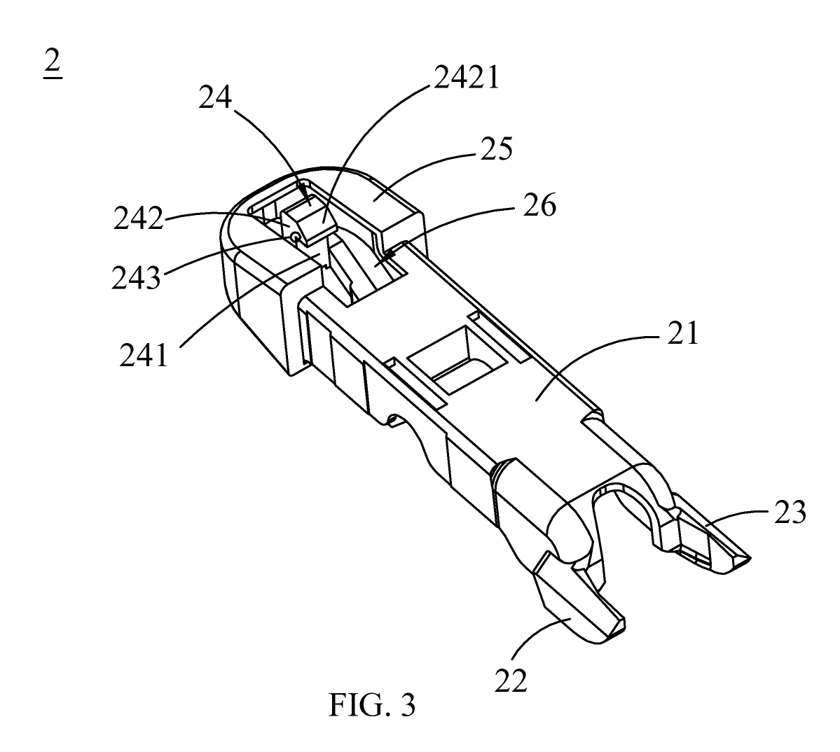

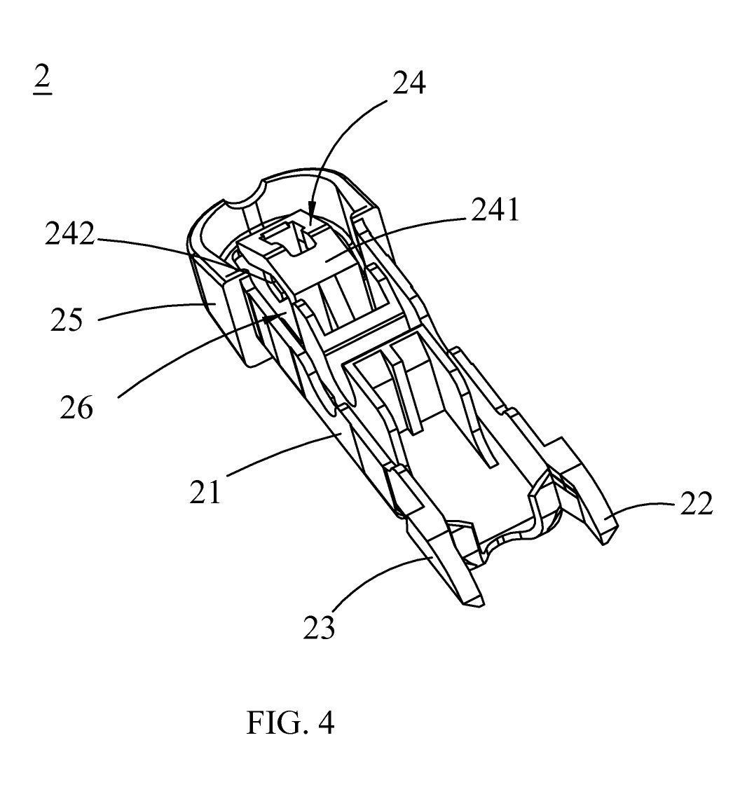

With reference to FIG. 3 and FIG. 4 for a first schematic diagram and a second schematic diagram of a windshield wiper connector in accordance with an embodiment of the invention are depicted. The first schematic diagram is a top view three-dimensional diagram of the windshield wiper connector 2, and the second schematic diagram is a bottom view three-dimensional diagram of the windshield wiper connector 2. The windshield wiper connector 2 of the embodiment comprises a main body 21, a first lodging portion 22, a second lodging portion 23, a flexible fastening body 24 and a containing portion 25. The main body 21 can be, but not limited to, an elongated structure. The first lodging portion 22 and the second lodging portion 23 can be respectively disposed to two sides of a rear of the main body 21. The shapes of hooking the first lodging portion 22 and the second lodging portion 23 with the first barb portion 11 and the second barb portion 12 of the windshield wiper arm 1 respectively match with the barb portions 11 and 12. The first lodging portion 22 and the second lodging portion 23 are flexible objects. The containing portion 25 can be connected to a front of the main body 21 and defines a containing space 26 for containing the flexible fastening body 24 together with the body. In the embodiment, the containing portion 25 is a U-shaped structure and can be, but not limited to actual practice, other structures capable of defining the containing space 26. The flexible fastening body 24 comprises a flexible portion 241 and a fastening portion 242. One end of the flexible portion 241 can be connected below the front of the main body 21, and another end of the flexible portion 241 is upwardly extended toward an upper side of the main body 21 and connected to the fastening portion 242 to become an extending end. The flexible fastening body 24 can be disposed in the containing space 26. The fastening portion 242 protrudes to the containing space 26. A recess 243 is formed at an intersection between the flexible portion 241 and the fastening portion 242. The size of the containing space 26 can allow the flexible fastening body 24 to perform a flexible deformation at suitable degrees so that the protruding portion 13 of the windshield wiper arm 1 to cross it. The fastening portion 242 further comprises a guiding surface 2421. When the guiding surface 2421 is deformed by the propping of the protruding portion 13, the surface is guided to cross the extending end. In the embodiment, the guiding surface 2421 is an oblique plane toward the protruding portion 13 and can be other patterns, such as an arc plane, a ladder plane, or the like, during the actual practice. In the subsequent depiction, the first lodging portion 22 and the second lodging portion 23 can also be called a lodging device. The flexible fastening body 24 can also be called a flexible fastening device.

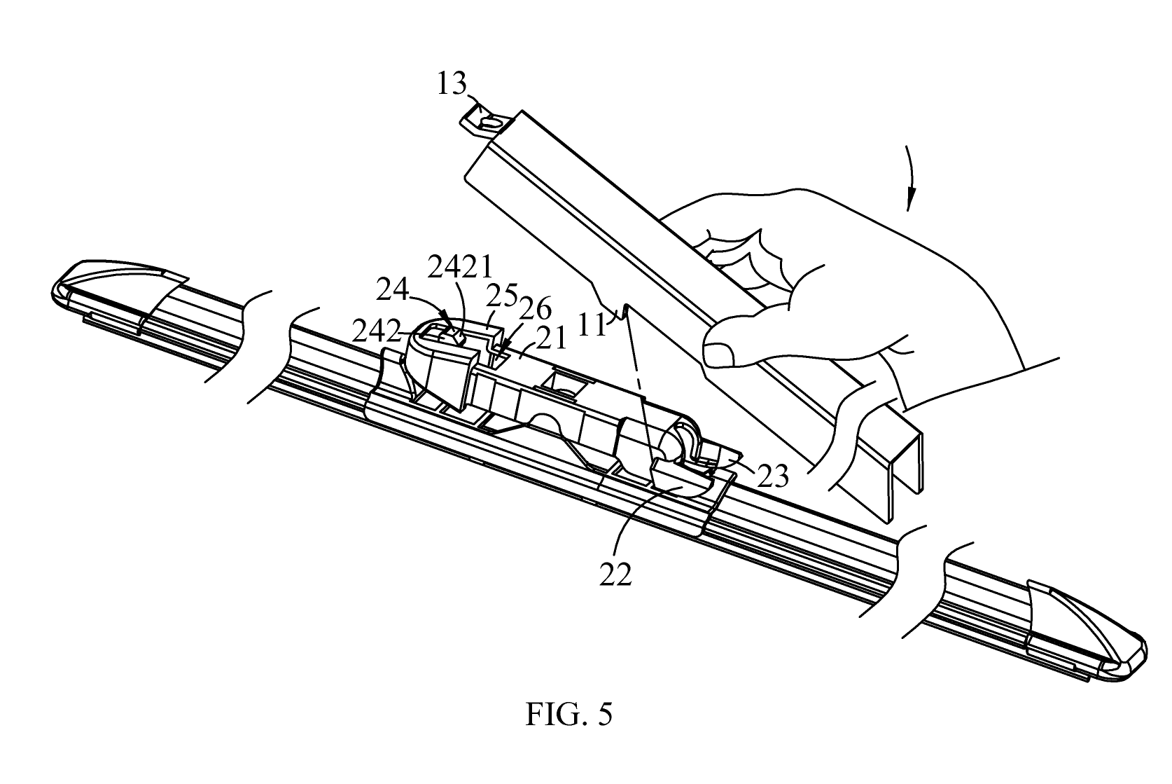

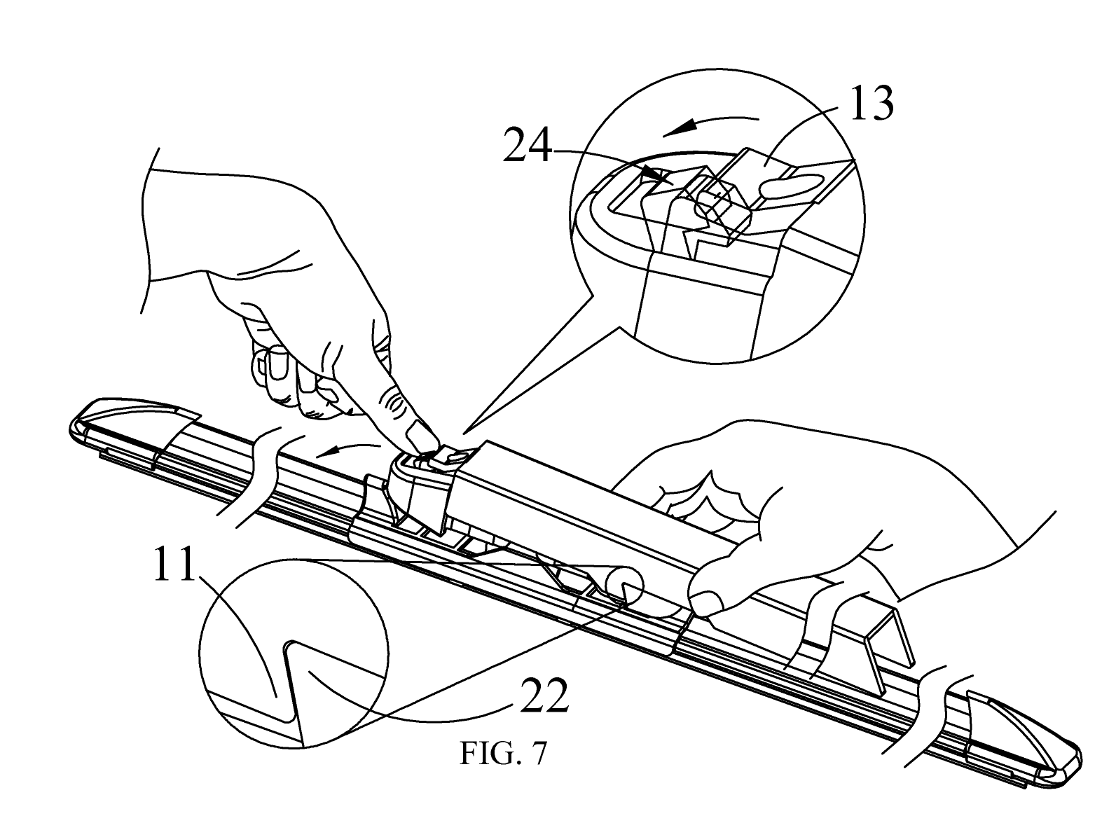

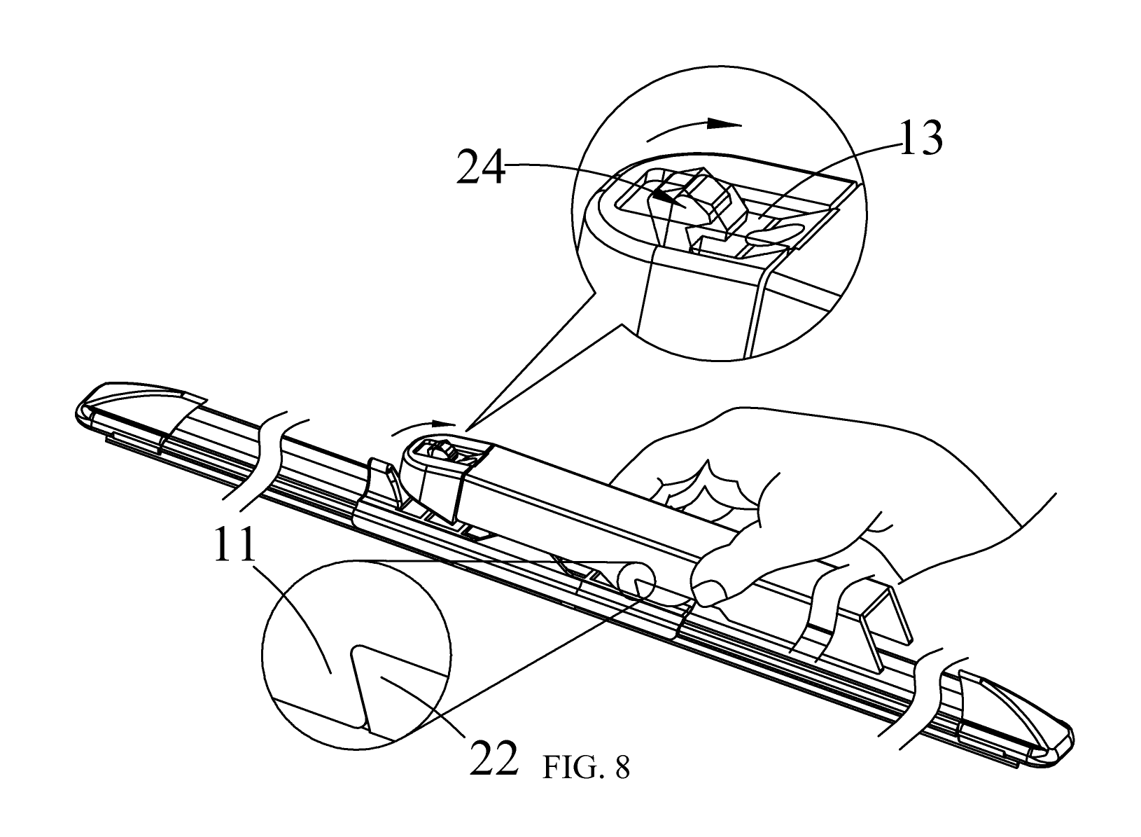

With reference to FIG. 5 to FIG. 8 for a first schematic diagram, a second schematic diagram, a third schematic diagram and a fourth schematic diagram of a windshield wiper connector and windshield wiper assembly in accordance with an embodiment of the invention are depicted. In the embodiment, a windshield wiper has been installed below the windshield wiper connector 2. If a user would like to assemble and combine the windshield wiper connector 2 and the windshield wiper arm 1, the windshield wiper arm 1 can be firstly placed above the windshield wiper connector 2 to allow the protruding portion 13 of the windshield wiper arm 1 to be toward a front of the main body 21 of the windshield wiper connector 2. Next, the first barb portion 11 and the second barb portion 12 of the windshield wiper arm 1 are firstly and respectively hooked with the first lodging portion 22 and the second lodging portion 23 of the windshield wiper connector 2. The windshield wiper arm 1 takes the hooking portion as an axis, and the front of the protruding portion 13 of the windshield wiper arm 1 is downwardly rotated. In the meantime, the protruding portion 21 of the windshield wiper arm 1 will gradually approach the flexible fastening body 24 of the windshield wiper connector 2. When the protruding portion 13 of the windshield wiper arm 1 is in contact with the guiding surface 2421 of the fastening portion 242 of the flexible fastening body 24, the protruding portion 13 is continuously rotated to prop the guiding surface 2421. Since the windshield wiper arm 1 is downwardly pushed by the pushing force, the flexible portion 21 of the flexible fastening body 24 performs a flexible deformation motion that is toward a direction being distant from the protruding portion 13. When the protruding portion 13 of the windshield wiper arm 1 crosses the fastening portion 242 along the guiding surface 2421 of the fastening portion 242, it would fall into the cavity 243 connected between the flexible portion 241 and the fastening portion 242. In the meantime, since the protruding portion 13 of the windshield wiper arm 1 does not push the fastening portion 242 of the flexible fastening body 24, the flexible portion 241 of the flexible fastening body 24 is flexibly restored from the deformed state such that the protruding portion 13 of the windshield wiper arm 1 leans against the cavity 243, and the fastening portion 242 of the flexible fastening body 24 is hooked with the protruding portion 13. The lodging motion of fastening the windshield wiper arm 1 to the windshield wiper connector 2 is completed.

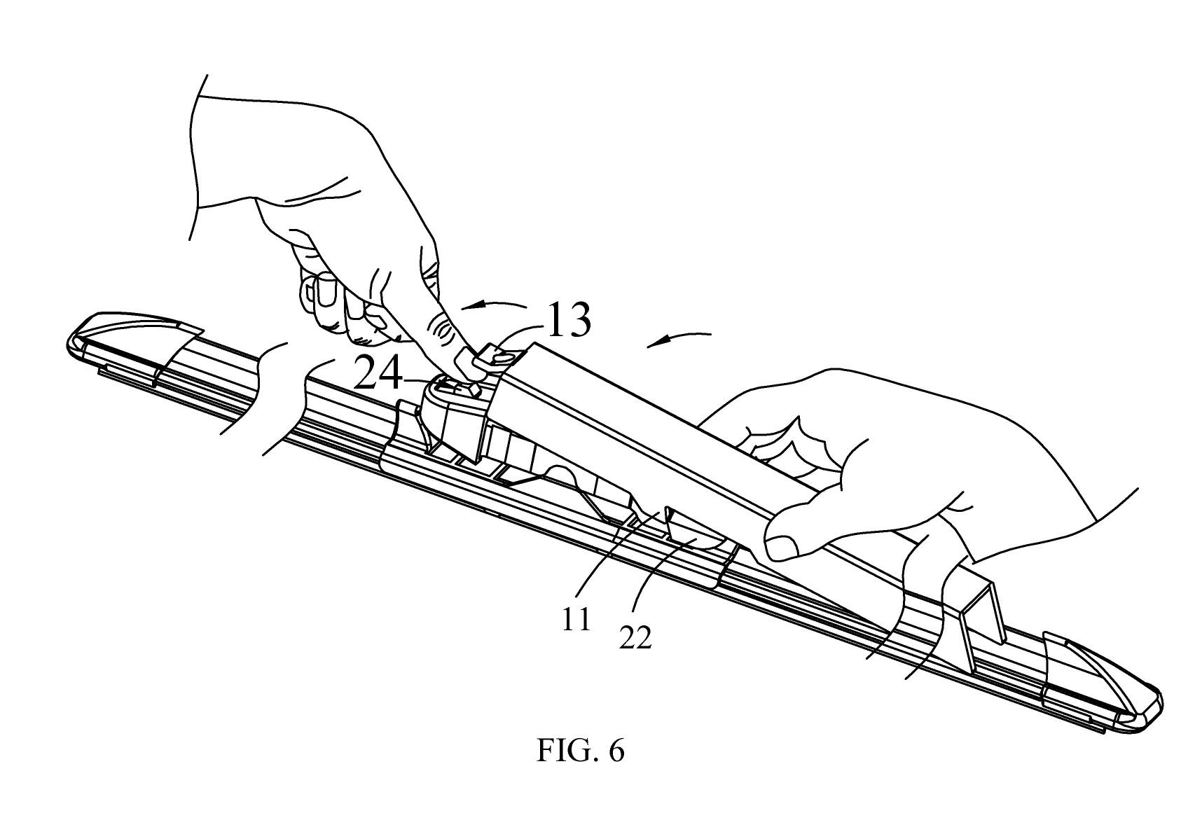

In the embodiment, since the windshield wiper connector 2 uses the flexible fastening body 24 with flexible material to fasten the protruding portion 13 of the windshield wiper arm 1, the size of the containing space 26 can allow the flexible fastening body 24 to perform a flexible deformation motion to facilitate the protruding portion 13 of the windshield wiper arm 1 crossing the fastening portion 242 of the flexible fastening body 24. Accordingly, the user does not need to impose magnitude forces to easily assemble and combine the windshield wiper arm 1 with the windshield wiper connector 2. A fewer interval is still retained between the first barb portion 11 and the second barb portion 12 of the windshield wiper arm 1 and the first lodging portion 22 and the second lodging portion 23 of the windshield wiper connector 2 as shown in FIG. 6. Therefore, the first barb portion 11 and the second barb portion 12 can be prevented from forcing and leaning against the first lodging portion 22 and the second lodging portion 23 to wear the first lodging portion 22 and the second lodging portion 23. When the connection between the windshield wiper arm 1 and the windshield wiper connector 2 is completed, the first lodging portion 22 and the second lodging portion 23 of the windshield wiper connector 2 can lean against the first barb portion 11 and the second barb portion 12 of the windshield wiper arm 1 to prevent the windshield wiper arm 1 from falling toward a rear direction of the main body 21 of the windshield wiper connector 2. The flexible fastening body 24 of the windshield wiper connector 2 can lean against the windshield wiper arm 1 to prevent the windshield wiper arm 1 from falling toward a front direction of the main body 21 of the windshield wiper connector 2. Since the fastening portion 242 of the flexible fastening body 24 is hooked with the protruding portion 13 of the windshield wiper arm 1, the windshield wiper arm 1 can be prevented from coming off an upper direction of the main body 21 of the windshield wiper connector 2.

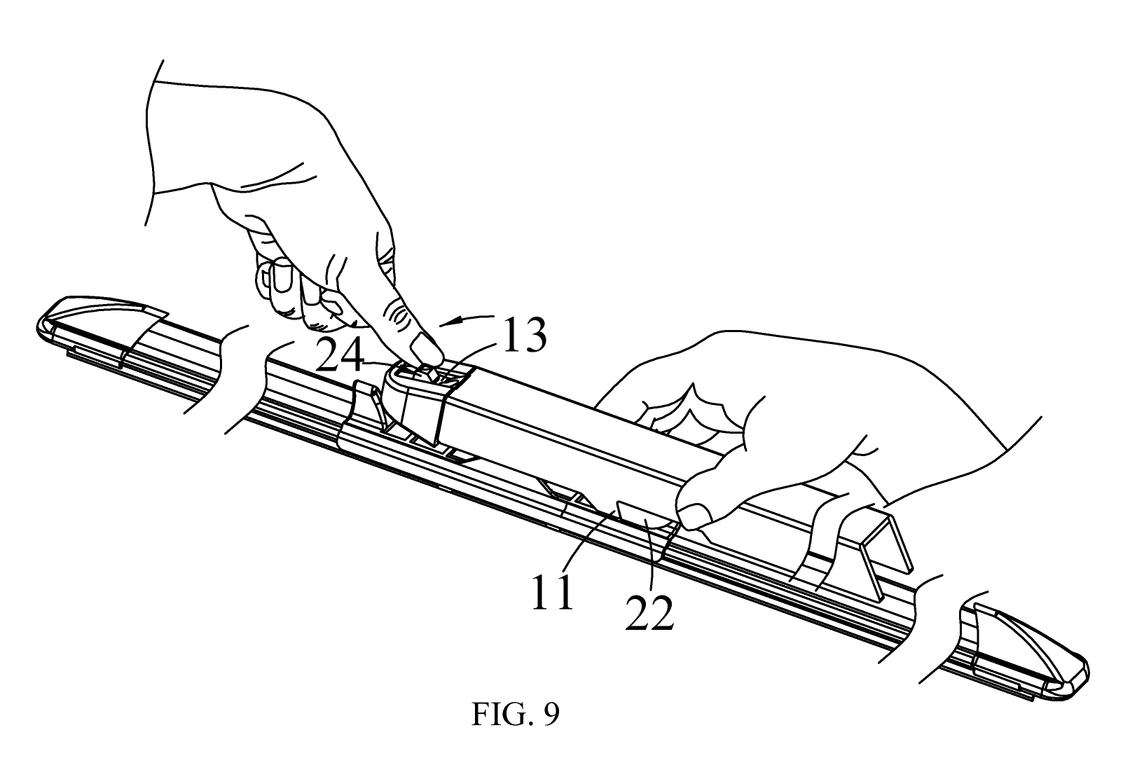

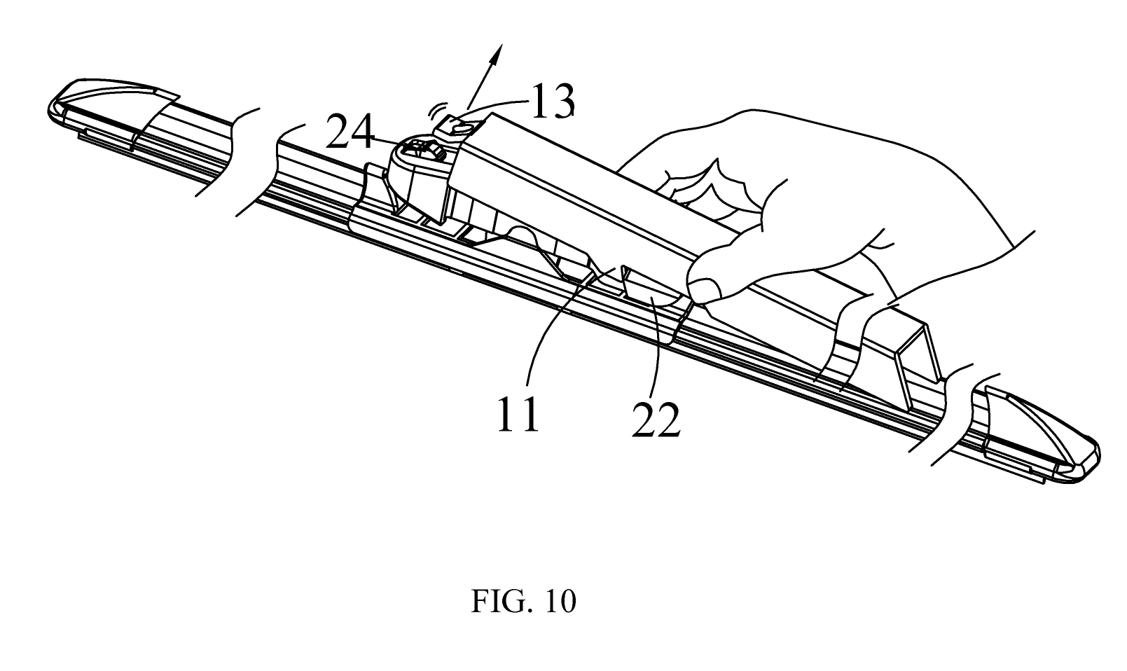

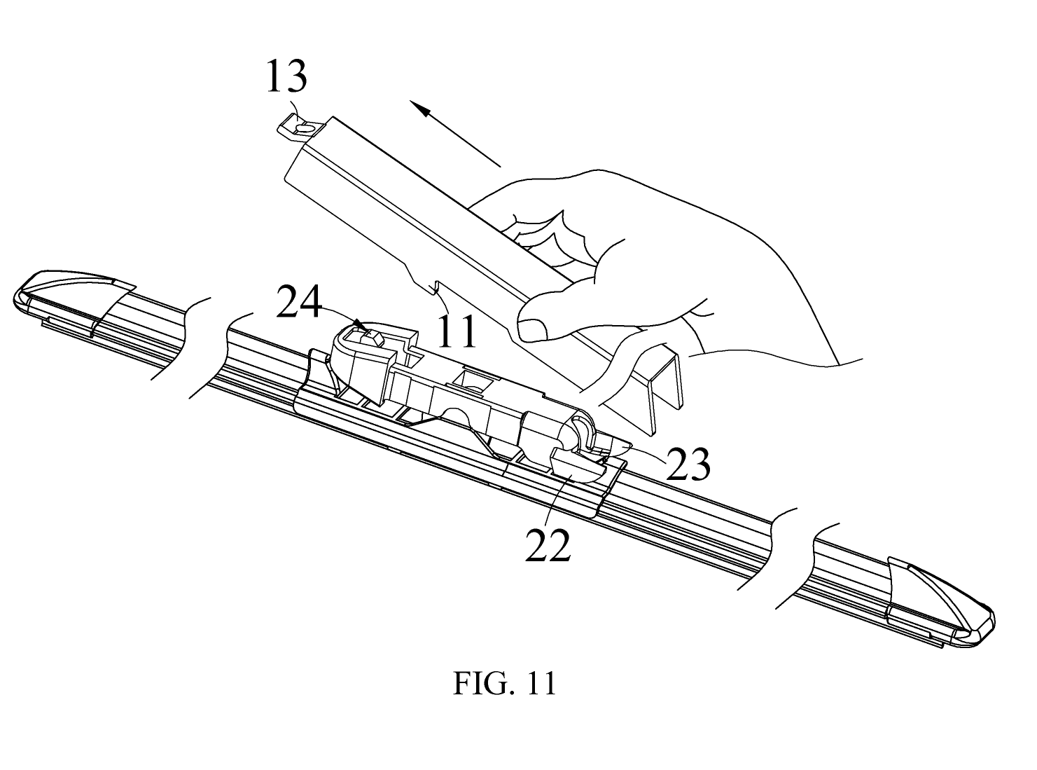

With reference to FIG. 9 to FIG. 11 for a first schematic diagram, a second schematic diagram and a third schematic diagram of detaching the windshield wiper arm from the windshield wiper arm in accordance with an embodiment of the invention are depicted. In the embodiment, if the user would like to detach the windshield wiper arm 1 from the windshield wiper connector 2, only needs to use fingers toggle the flexible fastening body 24 of the windshield wiper connector 2 to allow the protruding portion 13 of the windshield wiper arm 1 upwardly bouncing off so that both can be easily detached and separated.

The windshield wiper connector 2 of the invention can allow the user to conveniently connect the conventional windshield wiper arm 1. While detaching the windshield wiper arm 1 from the windshield wiper connector 2, the flexible fastening body 24 of the windshield wiper connector 2 is merely toggled to easily separate the windshield wiper connector 2 from the windshield wiper arm 1 so as to achieve the convenience regardless of assembly or detachment. With the flexible fastening body 24 of the windshield wiper connector 2 fastened to the protruding portion 13 of the windshield wiper arm 1 and the first lodging portion 22 and the second lodging portion 23 of the windshield wiper connector 2 leaning against the first barb portion 11 and the second barb portion 12 of the windshield wiper arm 1, the windshield wiper arm 1 is stably connected to the windshield wiper connector 2. Further, since the flexible fastening body 24, the first lodging portion 22 and the second lodging portion 23 are components made of flexible materials, the flexible fastening body 24 can be deformed at a direction. Accordingly, while detaching and assembling the windshield wiper connector 2 and the windshield wiper arm 1, a buffer can be obtained to greatly reduce the first barb portion 11 and the second barb portion 12 of the windshield wiper arm 1 damaging the first lodging portion 22 and the second lodging portion 23.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A windshield wiper connector comprising:
a main body;
a lodging device, disposed to a rear end of the main body, for mutually lodging a barb portion of a windshield wiper arm; and
a flexible fastening device, one end of the flexible fastening device connected below a front of the main body, another end of the flexible fastening device being an extending end upwardly extended toward an upper side of the main body, and the flexible fastening device being for leaning against a protruding portion of the windshield wiper arm;
wherein after the lodging device is lodged with the barb portion, the windshield wiper arm is rotated by taking a lodging portion of the lodging device as an axis so that the extending end of the flexible fastening device is propped by the protruding portion to firstly perform a deformation toward a direction being distant from the protruding portion, and when the protruding portion crosses the extending end, the extending end is restored from a deformation state to fasten the protruding portion so as to fix the windshield wiper arm on the main body.

2. The windshield wiper connector as recited in claim 1, further comprising a containing portion connecting the front of the main body and forming a containing space, the flexible fastening device located in the containing space.

3. The windshield wiper connector as recited in claim 2, wherein the containing portion is a U-shaped structure.

4. The windshield wiper connector as recited in claim 2, wherein the flexible fastening device comprises a flexible portion and a fastening portion, and one end of the flexible portion is disposed below the front of the main body, another end of the flexible portion is extended toward the upper side of the main body and connected to the fastening portion to become the extending end, and the fastening portion protrudes to the containing space, and the fastening portion comprises a guiding surface for guiding the protruding portion to cross the extending end when the extending end propped by the protruding portion is deformed.

5. The windshield wiper connector as recited in claim 4, wherein the flexible portion and the fastening portion are connected to form a cavity, and when the protruding portion of the windshield wiper arm is approached to the flexible fastening device, the guiding surface is propped by the protruding portion to allow the flexible portion performs the deformation toward the direction being distant from the protruding portion, and when the protruding portion crosses the extending end and falls into the cavity to mutually leaning against each other, the fastening portion is hooked with the protruding portion.

6. The windshield wiper connector as recited in claim 1, wherein the lodging device is a flexible object.

7. The windshield wiper connector as recited in claim 1, wherein the lodging device is connected to two sides of the rear of the main body.

8. The windshield wiper connector as recited in claim 1, wherein the main body is an elongated structure.

9. The windshield wiper connector as recited in claim 1, wherein the barb portion is disposed at two ends of the windshield wiper arm, and the protruding portion is disposed to one end of the windshield wiper arm.

10. A windshield wiper connection assembly comprising:
a windshield wiper connector comprising a main body, two sides of a rear of the main body disposed with a first lodging portion and a second lodging portion, a front of the main body disposed with a flexible fastening body, the flexible fastening body comprising a flexible portion and a fastening portion, the fastening portion further comprising a guiding surface; and
a windshield wiper arm, two sides of the windshield wiper arm having a first barb portion and a second barb portion and corresponding to the first lodging portion and the second lodging portion, one end of the windshield wiper arm having a protruding portion;
wherein the first lodging portion and the second lodging portion are respectively hooked with the first barb portion and the second barb portion, and the windshield wiper arm is rotated by taking a hooking portion as an axis so that the protruding portion is gradually approached to the guiding surface of the fastening portion and mutually leans against each other to allow the flexible portion performing a deformation toward a direction being distant from the protruding portion, and after the protruding portion crosses the fastening portion and is restored from the deformation, the fastening portion is fastened with the protruding portion so as to fix the windshield wiper arm on the main body.

11. The windshield wiper connection assembly as recited in claim 10, further comprising a containing portion connecting the front of the main body and forming a containing space, the flexible fastening body located in the containing space.

12. The windshield wiper connection assembly as recited in claim 11, wherein the containing portion is a U-shaped structure.

13. The windshield wiper connection assembly as recited in claim 11, wherein one end of the flexible portion is disposed below the front of the main body, another end of the flexible portion is extended toward an upper side of the main body and connected to the fastening portion to become an extending end, and the fastening portion protrudes to the containing space, and when the extending end propped by the protruding portion is deformed, the guiding surface is in contact with the protruding portion and guides the protruding portion to cross the extending end.

14. The windshield wiper connection assembly as recited in claim 13, wherein the flexible portion and the fastening portion are connected to form a cavity, and when the protruding portion leans against the guiding surface to allow the flexible portion to perform the deformation toward the direction being distant from the protruding portion, the protruding portion crosses the fastening portion and falls into the cavity from the guiding surface, and the fastening portion is fastened with the protruding portion.

15. The windshield wiper connection assembly as recited in claim 10, wherein the first lodging portion and the second lodging portion are flexible objects.

16. The windshield wiper connection assembly as recited in claim 10, wherein the main body is an elongated structure.
